(19) United States
(12) Patent Application Publication
(10) Pub. No.: US 2008/0140946 A1
(43) Pub. Date: Jun. 12, 2008

(54) APPARATUS, SYSTEM, AND METHOD FOR PROTECTING HARD DISK DATA IN MULTIPLE OPERATING SYSTEM ENVIRONMENTS

(76) Inventors: Mark Charles Davis, Durham, NC (US); Joseph Wayne Freeman, Raleigh, NC (US); Steven D. Goodman, Raleigh, NC (US); Howard Locker, Cary, NC (US); Randall Scott Springfield, Chapel Hill, NC (US); Rod D. Waltermann, Rougemont, NC (US)

Correspondence Address: Kunzler & McKenzie, 8 EAST BROADWAY, SUITE 600, SALT LAKE CITY, UT, 84111, US

(21) Appl. No.: 11/609,221

(22) Filed: Dec. 11, 2006

(51) Int. Cl. G06F 12/00

(52) U.S. Cl. 711/154; 711/E12.001

(57) ABSTRACT

An apparatus, system, and method are disclosed for protecting hard disk data in multiple operating system environments. The present invention restricts access of a hard file to a range of logical addresses using a controller module configured to access a hard file in response to a request for a logical address, a set zero module configured to add an offset value to each request for a logical address on a hard file, and a set max module configured to set a maximum logical address accessible on a hard file. The invention limits access to a lower protected area with logical addresses below the range of logical address and a host protected area with logical address above the range of logical addresses.

### BACKGROUND OF THE INVENTION

1. Field of the Invention

This invention relates to protecting hard disk data and more particularly relates to protecting areas of a hard disk from unauthorized access.

2. Description of the Related Art

Advances in technology have produced hard drives with very large capacities. The capacity of a modern hard drive is often substantially larger than required for use with a single operating system. These large hard drives have led some users to exploit the excess capacity by installing multiple operating systems on a single hard drive which can be selectively booted by the user.

There are several motivations for installing multiple operating systems. Among them are power users running different operating systems, such as Linux and Windows®, for different applications and corporate environments with multiple users operating the same computer. Another emerging use for multiple operating systems on the same hard drive is the home office, where a business user wishes to insulate an operating system from viruses, Trojan horses, and other corruption that can result from the activities of other family members.

Existing methods for using a single hard drive for multiple operating systems typically involve partitioning the drive into logical areas and allocating one or more partition to each operating system. When an operating system is selected, it boots from its allocated logical area. In addition to the allocated logical areas, the selected operating system has access to the entire contents of the hard drive, including the areas allocated to other operating systems. As a result, actions taken by one operating system can impact the other operating systems on the hard disk in the form of data corruption, data theft, or other undesirable outcomes.

Current PC hard file practice (as defined in the IDE/ATAPI standards) allows the disk to be divided into 2 distinct areas: 1) The lower (and usually larger) section of the drive that goes from logical block address (LBA) 0 to the top LBA. This portion of the drive is typically where the operating system and user programs and data reside. 2) A Host Protected Area (HPA) located at the top of the drive. This area is set up by issuing a “Set Max” command to the drive. The effect of this is to lower the “Top LBA” available to the lower operating system area of the drive. Once set, the operating system cannot see or access the HPA area of the drive.

This works fine for a disk housing a single operating system installed in the lower section of the hard drive. The O/S has complete access of everything from LBA 0 to the Top LBA. If the Top LBA has been lowered by a Set Max command, the area beyond the new Top LBA is immune from corruption by the operating system.

A problem arises when you have more than one operating system on the drive, since an operating system installed in the HPA has unfettered access to the lower section of the drive. As a result, an operating system in the lower section of the drive is vulnerable to malicious or accidental damage or theft due to actions of an operating system installed in the HPA.

### SUMMARY OF THE INVENTION

From the foregoing discussion, it should be apparent that a need exists for an apparatus, system, and method that protects hard disk data in multiple operating system environments. Beneficially, such an apparatus, system, and method would protect more than one area of a hard disk drive.

The present invention has been developed in response to the present state of the art, and in particular, in response to the problems and needs in the art that have not yet been fully solved by currently available hard disk data protection schemes. Accordingly, the present invention has been developed to provide an apparatus, system, and method for protecting hard disk data that overcome many or all of the above-discussed shortcomings in the art.

The apparatus to restrict access of a hard file to a range of logical addresses is provided with a plurality of modules configured to functionally execute the necessary steps of restricting access of a hard file to a range of logical addresses. These modules in the described embodiments include a controller module configured to access a hard file in response to a request for a logical address, a set zero module configured to add an offset value to each request for a logical address on a hard file, and a set max module configured to set a maximum logical address accessible on a hard file.

The apparatus, in one embodiment, is further configured to determine the offset value by a selection among a plurality of hard file areas such that a selection of an area occupying a higher range of logical addresses results in a larger offset value. In a further embodiment, the apparatus defines a plurality of hard file areas on a hard file in a geometry table, the geometry table comprising a plurality of offset values, each of the plurality of offset values corresponding to the lowest logical address of one of the plurality of hard disk drive areas, and a plurality of maximum logical address, each of the plurality of maximum logical addresses corresponding to the highest logical address of one of the plurality of hard disk drive areas.

In another embodiment, the set max module sets a maximum logical address relative to the native logical address system of the hard file. In an alternate embodiment, the set max module sets a maximum logical address relative to the offset value.

In a further embodiment, the apparatus further comprises a locking module configured to lock the set zero module such that the set zero module is restricted from changing the offset value, and unlock the set zero module such that the set zero module is allowed to change the offset value. The locking module, in one embodiment, is further configured to unlock the set zero module in response to a password. In another embodiment, the locking module is further configured to lock the set zero module in response to a set zero command.

A system to protect hard disk data in multiple operating system environments is also presented. In one embodiment, the system comprises a motherboard configured to request data residing on a hard disk drive at a logical address, a controller module configured to control a hard disk drive, the controller module comprising a set zero module configured to add an offset value to each request for a logical address on a hard disk drive, and a set max module configured to set a maximum address accessible on a hard disk drive, and a hard disk drive configured to store data at logical addresses.

In a further embodiment of the system, the set zero module is an element of a hard disk controller integrated with the motherboard. In an alternate embodiment, the set zero module is an element of a stand alone hard disk controller. In another embodiment, the set zero module is an element of the hard disk drive.

The offset value, in one embodiment of the system, is determined by a selection among a plurality of operating systems, the plurality of operating systems occupying a corresponding plurality of hard disk drive areas, such that a selection of an operating system corresponding to an area occupying a higher range of logical addresses results in a larger offset value. In a further embodiment, the selection among a plurality of operating systems is restricted by a password.

In another embodiment of the system, a plurality of hard disk drive areas on a hard disk drive are defined in a geometry table, the geometry table comprising a plurality of offset values, each of the plurality of offset values corresponding to the lowest logical address of one of the plurality of hard disk drive areas, and a plurality of maximum logical address, each of the plurality of maximum logical addresses corresponding to the highest logical address of one of the plurality of hard disk drive areas. In a further embodiment, the geometry table is stored with a basic input/output system (BIOS) in communication with the controller module. In another embodiment, the geometry table is stored on the hard disk drive.

A computer program product comprising a computer readable medium having computer usable program code programmed for restricting access of a hard file to a range of logical addresses is also provided. The operations of the computer program product include receiving a selection among a plurality of hard file areas on a hard file, accessing a geometry table, the geometry table comprising a plurality of offset values, each of the plurality of offset values corresponding to the lowest logical address of one of the plurality of hard disk drive areas and a plurality of maximum logical address, each of the plurality of maximum logical addresses corresponding to the highest logical address of one of the plurality of hard disk drive areas, adding the offset value to each request for a logical address on the hard file denying access to logical addresses higher than the maximum logical address.

In a further embodiment, accessing the geometry table comprises a basic input/output system (BIOS) reading non-volatile BIOS memory. In another embodiment, accessing the geometry table comprises a boot loader reading data stored on the hard file.

A method for restricting access of a hard disk drive to a range of logical addresses is also presented. The method, in one embodiment, comprises receiving a selection among a plurality of hard disk drive areas on a hard disk drive, accessing a geometry table, the geometry table comprising a plurality of offset values, each of the plurality of offset values corresponding to the lowest logical address of one of the plurality of hard disk drive areas and a plurality of maximum logical address, each of the plurality of maximum logical addresses corresponding to the highest logical address of one of the plurality of hard disk drive areas, adding the offset value to each request for a logical address on the hard disk drive, and denying access to logical addresses higher than the maximum logical address.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a hard drive with a host protected area;

FIG. 2 is a schematic block diagram illustrating one embodiment of system for protecting one or more areas of a hard disk drive in accordance with the present invention;

FIG. 3 is a schematic block diagram illustrating one embodiment of an apparatus for protecting one or more areas of a hard disk drive in accordance with the present invention;

FIG. 4 is a schematic block diagram illustrating one embodiment of a geometry table for protecting one or more areas of a hard file in accordance with the present invention;

FIG. 5 is a schematic block diagram illustrating one embodiment of a locking module for protecting one or more areas of a hard file in accordance with the present invention;

FIG. 6 is a schematic block diagram illustrating one embodiment of an apparatus for protecting one or more areas of a hard disk drive using a geometry table accessed by a BIOS in accordance with the present invention;

FIG. 7 is a schematic block diagram illustrating one embodiment of an hard disk drive configured to protect one or more areas of the hard disk drive using a geometry table stored on the hard disk drive in accordance with the present invention; and

FIG. 8 is a schematic flow chart diagram illustrating one embodiment of a method for protecting one or more areas of a hard file in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Reference to “hard disk drive,” “hard drive,” “hard disk,” “hard file,” or similar language refers to any digitally-encoded, non-volatile storage device. Examples of these storage devices include hard disk drives using rotating disk platters with magnetic surfaces, magnetic tape, optical disks such as CD or DVD-ROMS, read-only memory, flash memory including universal serial bus (USB) keys and flash cards, and the like. Combinations of the above examples, such as a multi-disk RAID subsystem with a unified logical addressing scheme should also be considered to be a hard disk drive for the purposes of the invention.

Reference to “area” of a hard disk drive refers to a group of storage locations on a hard disk drive. The group of locations may be, but need not be, contiguous. The storage locations on the hard disk drive may be represented by a logical addressing scheme that maps physical storage locations to logical addresses. For example, a hard disk drive with physical storage locations of cylinders, heads, and sectors may be represented by a logical block addressing (LBA) which assigns an address to physical locations on the hard disk drive, with the first, or lowest, address assigned LBA 0, the next LBA 1, and so on.

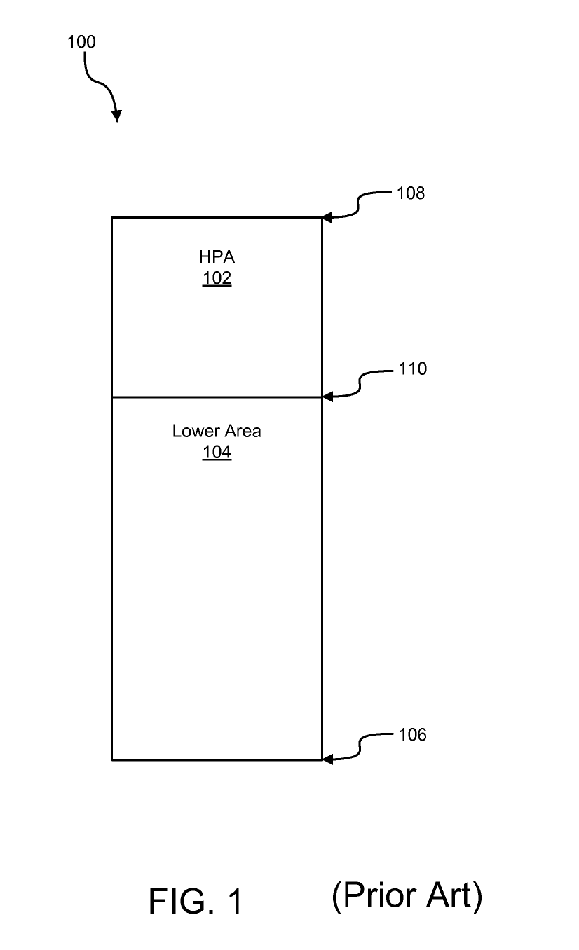

FIG. 1 illustrates one embodiment of a hard disk 100 with host protected area (HPA) 102 and a lower area 104. The hard disk 100, in one embodiment, is accessed through a logical addressing scheme that assigns a range of addresses to physical storage locations in the hard disk 100 ranging from zero 106 to the top logical address 108. The current standards for hard file practice in a personal computer (PC), the integrated device electronics (IDE)/advanced technology attachment packet interface (ATAPI) standards, include a specification for a “set max” command. When the set max command is issued to the hard drive 100 with an associated new logical top address 110, logical addresses above the new logical top address 110 and the top logical address 108 under the native addressing scheme of the hard disk 100 become inaccessible. By issuing a set max command, the HPA 102 of the hard disk 100 is effectively protected from an operating system using the lower area 104, as the operating system is unable to access logical addresses above the new logical top address 110.

If, however, an operating system is installed in the HPA 102, the operating system will only function if the set max command is not issued. An operating system in the HPA 102 will, therefore, have access to any data stored in the lower area 104. As a result, only an operating system installed in the HPA 102 receives protection from the set max command, and a second operating system installed in the lower area 104 receives no such protection.

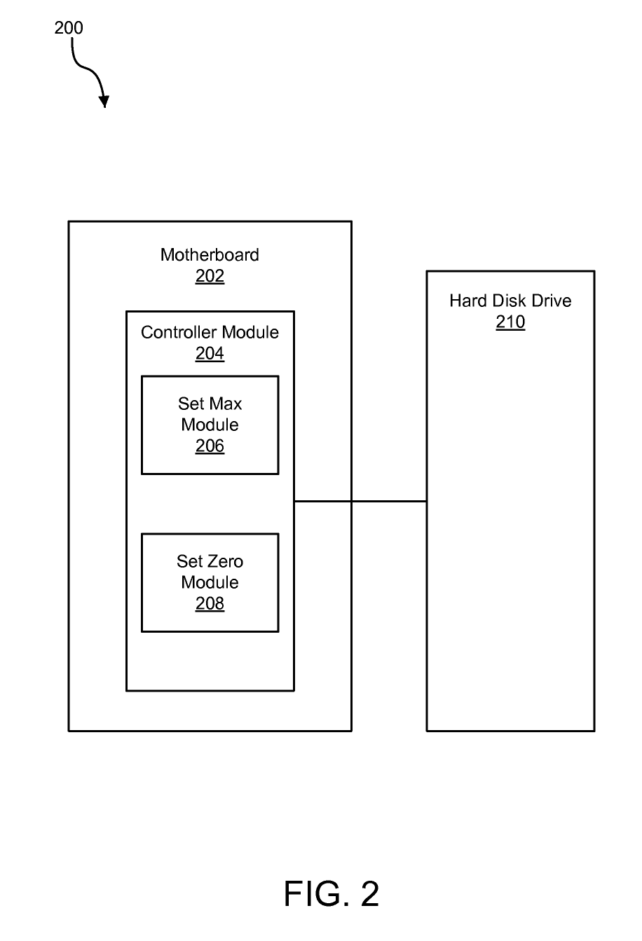

FIG. 2 illustrates one embodiment of system 200 for protecting one or more areas of a hard disk drive in accordance with the present invention. Included in the system 200 are a motherboard 202, a controller module 204, a set max module 206, a set zero module 208, and a hard disk drive 210. The system 200 restricts access of a hard disk drive 210 to a range of logical addresses.

The motherboard 202, in one embodiment, is the primary circuit board of a complex electronic system, such as a computer. The motherboard 202 links together and controls several components to perform computing tasks. The motherboard 202 may include a controller module 204. In another embodiment, the motherboard 202 may include a connector for a controller module 204. An example of a connector for a controller module 204 is a peripheral component interconnect (PCI) slot.

The controller module 204, in one embodiment, manages communication between a motherboard 202 and a hard disk drive 210. The controller module 204 may include a set max module 206 and a set zero module 208. The controller module 204 may issue commands to the hard disk drive 210 to read or write data at a storage address. In one embodiment, the controller module 204 may translate between a logical address scheme and physical storage addresses. In another embodiment, the controller module 204 may request logical addresses which are translated by the hard disk drive 210.

As will be appreciated by one skilled in the art, several implementations of controller module 204 are possible and should be considered to be within the scope of the invention. For example, the controller module 204 may be integrated with the motherboard 202. In another embodiment, the controller module 204 may be an add-on peripheral separate from the motherboard 202 and the hard disk drive 210. In yet another embodiment, the controller module 204 may be integrated with the hard disk drive 210. In a further embodiment, the controller module 204 may have its functional modules distributed among the components of the system 200.

In one embodiment, the set max module 206 issues a set max command to the hard disk drive 210. The set max command lowers the available top logical address on the hard disk drive 210. As a result, data stored above the new logical top address is protected from access while the set max command is in effect.

The set zero module 208, in one embodiment, issues a “set zero” command to the hard disk drive. The set zero command raises the available zero address of the hard disk drive 210 to a new zero address. As a result, data stored below the new zero address is protected from access while the set zero command is in effect.

In one embodiment, the set zero command may cause the controller module 204 to add an offset value to all requests for a logical address on the hard disk drive 210. For example, the set zero module 208 may cause the controller to add an offset of 20,000 to all requests for logical addresses on the hard disk drive 210. Under this example, a request for logical address ten would have the offset of 20,000 added to the address, and the controller would access logical address 20,010 under the native addressing scheme of the hard disk drive 210.

The hard disk drive 210, in one embodiment, is a digitally encoded, non-volatile storage device. The hard disk drive 210 may be accessed through a logical addressing scheme that translates between logical addresses and physical storage locations, such as LBA. For example, a physical area on a hard disk drive 210 may be assigned a logical address of zero. Another physical area of the hard disk drive 210 may be assigned a logical address of one, and so forth.

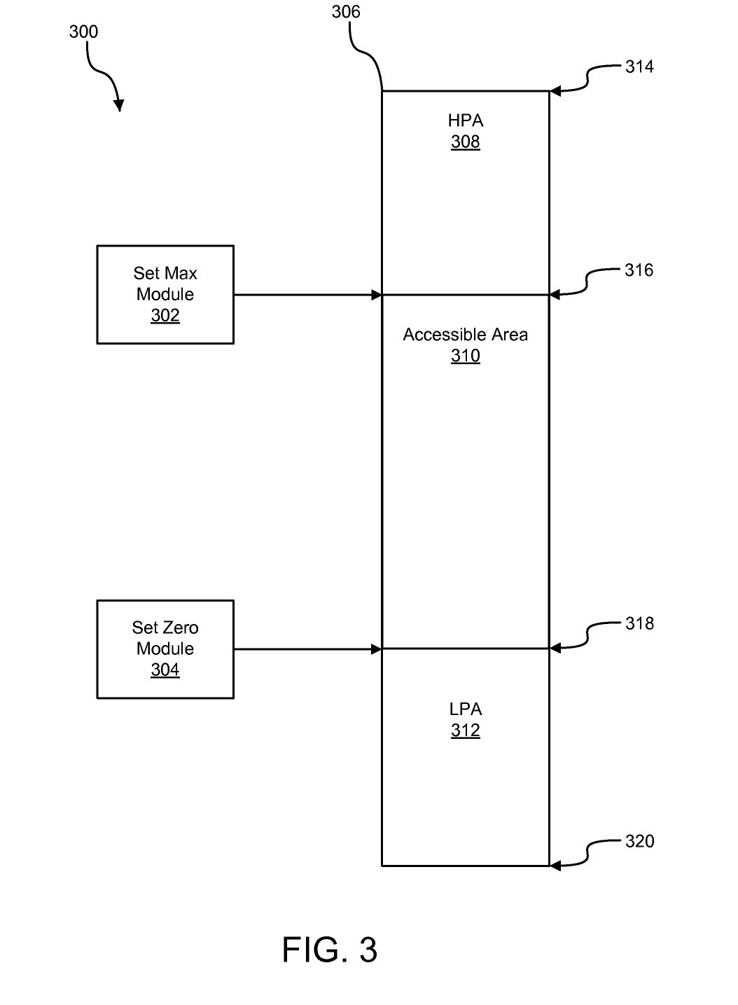

FIG. 3 illustrates one embodiment of an apparatus 300 for protecting one or more areas of a hard disk drive 306 in accordance with the present invention. The apparatus 300 may include a set max module 302, a set zero module 304, and a hard disk drive 306. The apparatus 300 protects the data stored on one or more areas of the hard disk drive 306 while a different area of the hard disk drive 306 is accessible by restricting access to the protected area or areas.

In one embodiment, the hard disk drive 306 includes physical storage locations accessed by logical addresses. The logical addresses may range from a drive logical zero address 320 to a drive logical top address 314. Data may be stored on the hard disk drive 306 for access.

The set zero module 304, in one embodiment, is configured to issue a set zero command for the hard disk drive 306. The set zero command establishes a new logical zero address 318 for the hard disk drive 306. In one embodiment, the set zero command results in the addition of an offset value to requests for a logical address on the hard disk drive 306. The offset value in this embodiment is equal to the hard disk drive logical address of the new logical zero address 318. As a result of the addition of the offset value, a request for logical address zero will be mapped to the new logical zero address 318. Similarly, a request for logical address one will be mapped to of hard disk drive logical address of the new logical zero address 318 plus one. Due to the addition of the offset value, native logical addresses of the hard disk drive 306 between the logical zero address 320 and the new logical zero address 318 are rendered inaccessible, forming a lower protected area (LPA) 312.

The set max module 302, in one embodiment, is configured to issue a set max command for the hard disk drive 306. The set max command lowers the available top logical address on the hard disk drive 306. As a result, data stored above the new logical top address 316 is protected from access while the set max command is in effect, forming a host protected area (HPA) 308.

The set max module 302, in one embodiment, issues a set max command that indicates a new top logical address 316 relative to the native logical addressing scheme of the hard disk drive 306. For example, the set max module 302 may issue a set max command indicating a logical address of the hard disk drive 306 to become the new logical top address 316. In this example, if a new logical zero address 318 has been created, an offset value equal to the new logical zero address 318 is subtracted from the new top logical address 316 when a request for a logical address is issued to determine if the logical address is below the new logical top address 316.

In another embodiment, the set max module 302 may issue a set max command that indicates a new top logical address 316 relative to a new logical zero address 318. For example, the set max module may issue a set max command indicating the number of logical addresses allowable in an accessible area 310 between the new logical zero address 318 and the new logical top address 316. In this example, the offset value is not subtracted from the new top logical address 316 when a request for a logical address is issued to determine if the logical address is below the new logical top address 316.

In one embodiment, the hard disk drive 306 may be under the influence of a set max command and a set zero command, issued by the set max module 302 and the set zero module 304, respectively. The set max command may lower the highest logical address available for access from the drive logical top address 314 to a new logical top address 316. As a result of the set max command, an HPA 308 is formed in logical addresses between the new logical top address 316 and the drive logical top address 314. Data in the HPA 308 is rendered inaccessible and therefore protected.

The set zero command issued by the set zero module 304, in one embodiment, results in the addition an offset value to requests for access to a logical address on the hard disk drive 306. Under the influence of a set zero command, a request for access to logical address zero accesses a new logical zero address 318. The new logical zero address 318 is located at a logical address equal to the offset value under the original logical address scheme of the hard disk drive 306. As a result of the set zero command, an LPA 312 is formed in logical addresses between the drive logical zero address 320 and the new logical zero address 318. Data in the LPA 312 is rendered inaccessible and therefore protected. Data stored between the new logical zero address 318 and the new logical top address 316 forms an accessible area 310 where data stored on the hard disk drive 306 can be accessed.

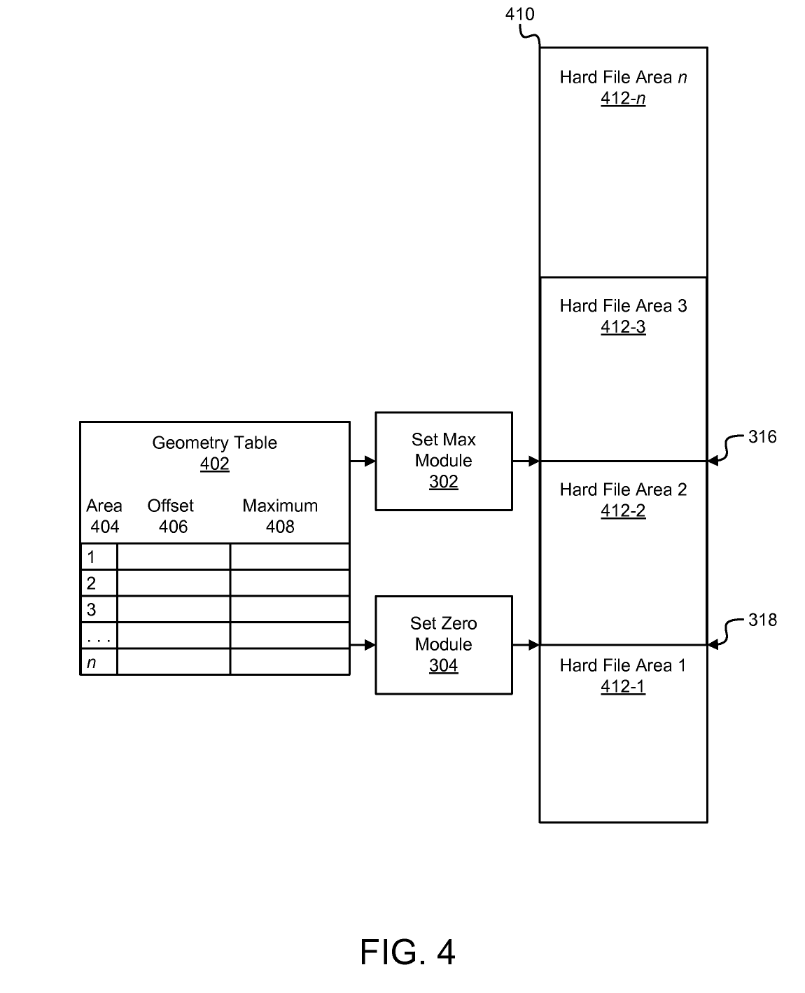

FIG. 4 illustrates one embodiment of a geometry table 402 for protecting one or more areas of a hard file 410 in accordance with the present invention. The geometry table 402 stores data relating to the logical addresses of one or more hard file areas 412-1-412-n. The geometry table 402 includes entries for area index 404, offset 406, and maximum 408.

The hard file 410, in one embodiment, may be any digitally-encoded, non-volatile storage device and may be accessed through a logical addressing scheme, such as LBA. The hard file 410 may include one or more hard file areas 412-1-412-n. An individual hard file area 412 on the hard file 410 may be protected from access while any other hard file area 412 is operating through the use of a set max module 302 and a set zero module 304 as described in relation to FIG. 3.

For example, while hard file are 412-2 is operating, the set zero module 304 issues a set zero command that prevents access to the hard file 410 at addresses below a new logical zero address 318 at the lowest logical address of hard file area 2 412-2. The set max module 302 issues a set max command that prevents access to the hard file 410 at logical addresses above a new logical top address 316. As a result of the set zero command and the set max command, only the logical addresses comprising hard file area 2 412-2 are accessible.

The geometry table 402, in one embodiment, provides information to the set max module 302 and the set zero module 304 indicating the proper addresses for the new logical top address 316 and the new logical zero address 318. The geometry table may include an area index 404, an offset value for each area 406, and a maximum address for each area 408.

In one embodiment, the area index 404 includes an index for each of the one or more hard file areas 412-1-412-n. For example, the area index 404 may comprise a number for each hard file area 412-1-412-n. In another example, the area index 404 may comprise a text string for each hard file area 412-1-412-n.

The offset value for each area 406, in one embodiment, contains values corresponding to a new logical zero address 318 associated with each hard file area 412-1-412-n. For example, the offset value for each area 406 may comprise a logical address of the hard file 410 for a new logical zero address 318 associated with each value in the area index 404. The offset value for each area 406 may be added to requests for a logical address when a hard file area 412-1-412-n is in operation.

The maximum address for each area 408, in one embodiment, contains values corresponding to a new logical top address 316 associated with each hard file area 412-1-412-n. For example, maximum address for each area 408 may comprise a logical address of the hard file 410 for a new logical top address 316 associated with each value in the area index 404. In another embodiment, the maximum address for each area 408 may comprise a value indicating the number of logical addresses between the new logical zero address 318 and the new logical top address 316.

As will be appreciated by one skilled in the art, a variety of configurations of geometry table 402 can be implemented without departing from the scope of the invention. For example, in one embodiment, the geometry table 402 may operate such that only the offset value for each area 406 is stored, and the maximum address for each area 408 is inferred to be one logical address less than the offset value of the next hard file area 412-1-412-n−1, while the maximum address for hard file area 412-n is presumed to be the maximum address of the hard file 410. Similarly, in another embodiment, the geometry table 402 may operate such that only the maximum address for each area 408 is stored, and the offset value for each area 406 is inferred to be one logical address less than the maximum value of the previous hard file area 412-2-412-n, while the offset value for hard file area 412-1 is presumed to be zero.

In one embodiment, the use of a geometry table 402 for protecting one or more hard file areas 412-1-412-n of a hard file 410 makes it possible for a plurality operating systems to be installed on the same hard file 410 while preventing each of the plurality of operating systems from accessing the data used by any of the other operating systems. For example, an operating system may be installed in each of the one or more hard file areas 412-1-412-n. In this example, an operating system installed in hard file area 412-2 can access the data in hard file area 2 412-2, but due to the set max command issued by the set max module 302, the operating system cannot access the data used by an operating system installed on hard file area 3 412-3-412-n. Similarly, the operating system in hard file area 2 412-2 cannot access data used by an operating system installed on hard file area 1 412-1 due to the set zero command issued by the set zero module 304. In one embodiment, a user may select among the plurality of operating systems. In response to the selection, the set max module 302 and the set zero module 304 issue a set max command and a set zero command to define the hard file area 412 corresponding to the selected operating system. In a further embodiment, the selection of an operating system requires a password.

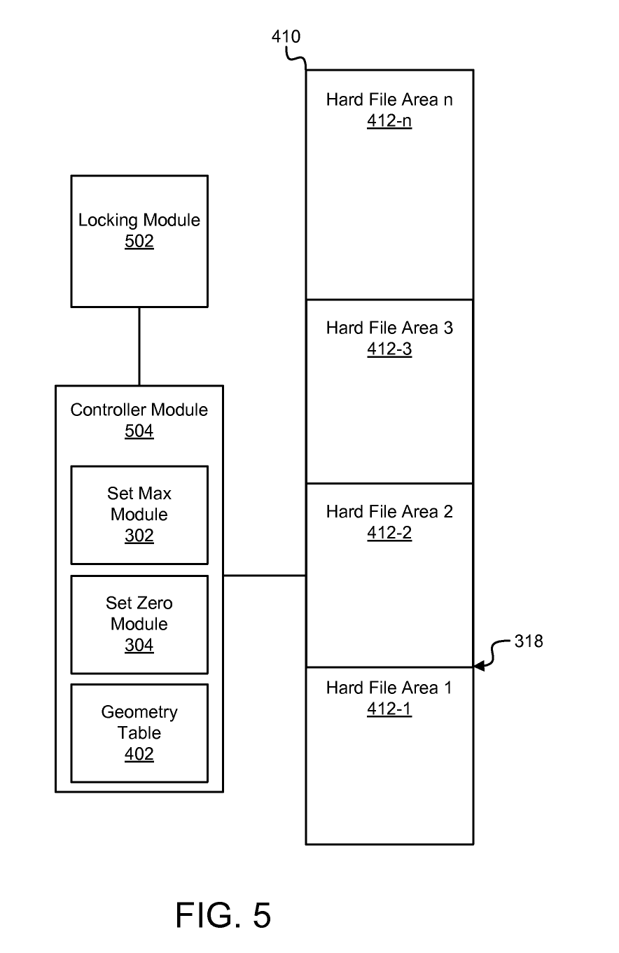

FIG. 5 illustrates one embodiment of a locking module 502 for protecting one or more areas of a hard file 410 in accordance with the present invention. The locking module 502, in one embodiment, interacts with a controller module 504 to protect areas of a hard file 410 from access.

In one embodiment, the controller module 504 controls access to the hard file 410. The controller module 504 may include a set max module 302, a set zero module 304, and a geometry table 402. The hard file 410 may include one or more hard file areas 412-1-412-n. The set max module 302, the set zero module 304, and the geometry table 402 are preferably configured to control access to the one or more hard file areas 412-1-412-n on a hard file 410 in a similar manner to like-numbered components described in relation to FIG. 4.

The locking module 502, in one embodiment, interacts with the controller module 504 to regulate the operation of the set zero module 304. The locking module 502 may lock the set zero module 304 such that the set zero module is restricted from changing the offset value. For example, an operating system on hard file area 2 412-2 may be operating under a set zero command issued previously by the set zero module 304. In this example, areas below a new logical zero address 318 are protected from access. If the set zero module 304 is restricted by the locking module 502, malicious or unauthorized attempts to change the new logical zero address 318 are denied.

In one embodiment, the locking module 502 unlocks the set zero module 304 in response to a password. In response to the proper password, the locking module 502 allows the set zero module 304 to issue a set zero command. For example, a set zero command may be requested with an offset value and a password. The locking module 502, in this example, allows the set max module 302 to issue the set zero command in response to the password, and the set zero module 304 issues a set zero command creating a new logical zero address 318 using the supplied offset value.

In a further embodiment, the locking module 502 is configured to automatically lock the set zero module 302 in response to the issuance of a set zero command. For example, a set zero command may be issued by the set zero module 304 to establish a new logical zero address 318. In response to issuing the set zero command, the locking module 502 locks the set zero module 304. In this example, a new request for the issuance of a set zero command is denied.

As will be appreciated by one skilled in the art, a variety of types and configurations of locking module 502 can be utilized without departing from the scope of the present invention. For example, the locking module 502 may be separate from the controller module 504. In another embodiment, the locking module 502 may be integrated with the controller module 504. In yet another embodiment, the locking module 502 may be integral with the set zero module 304. In a further embodiment, the locking module 502 may be an element of the hard file 410.

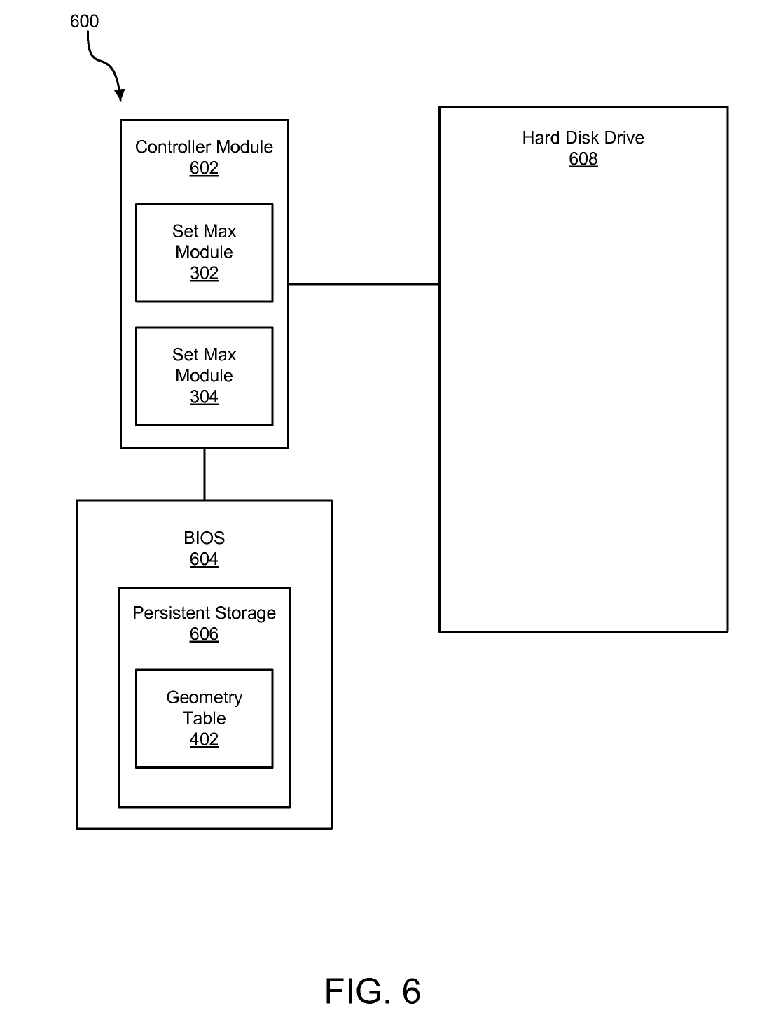

FIG. 6 illustrates one embodiment of an apparatus 600 for protecting one or more areas of a hard disk drive 608 using a geometry table 402 accessed by a basic input/output system (BIOS) 604 in accordance with the present invention. The apparatus 600 includes a controller module 602 and a BIOS 604. The apparatus protects one or more areas of a hard disk drive 608 by setting a new logical zero address and a new logical top address for an area of the hard disk drive 608.

The controller module 602, in one embodiment, controls access to the hard disk drive 608. The controller module 602 may include a set max module 302 and a set zero module 304. The set max module 302 and the set zero module 304 are preferably configured in a similar manner to like numbered components described in relation to FIG. 3.

The BIOS 604, in one embodiment, is software code configured to prepare a computer for other software, such as an operating system, to access the hardware of the computer. The BIOS 604 may include non-volatile BIOS memory (persistent storage) 606. The BIOS 604 may accesses a geometry table 402 stored by the persistent storage 606. The geometry table 402 is preferably configured in a similar manner to a like numbered component described in relation to FIG. 4. The BIOS 604 may be in communication with the controller module 602.

In one embodiment, the BIOS 604 accesses the geometry table 402 to retrieve information relating to hard disk drive areas on the hard disk drive 608 by reading the persistent storage 606. The BIOS may select a hard disk drive area for access and communicate with the controller module 602 to direct the controller module 602 to issue a set zero command and/or a set max command that limits access to the hard disk drive 608 to a selected area of the hard disk drive 608. For example, the BIOS 604 may access the geometry table 402 by reading the persistent storage 606 to determine an offset value and a new logical top address for a hard disk drive area on the hard disk drive 608. The BIOS may use the offset value and the new logical top address to direct the controller module 602 to issue a set zero command and a set max address command to the hard disk drive 608. Access to the hard disk drive 608 is limited to the selected hard disk drive area in response to the commands issued to the hard disk drive 608.

As will be appreciated by one skilled in the art, a variety of configurations of BIOS 604 may be implemented without departing from the scope of the invention. For example, the BIOS 604 may access a geometry table 402 stored separately from the BIOS 604. In one embodiment, the geometry table 402 may be stored with the controller module 602. In another embodiment, the geometry table 402 may be stored on the hard disk drive 608.

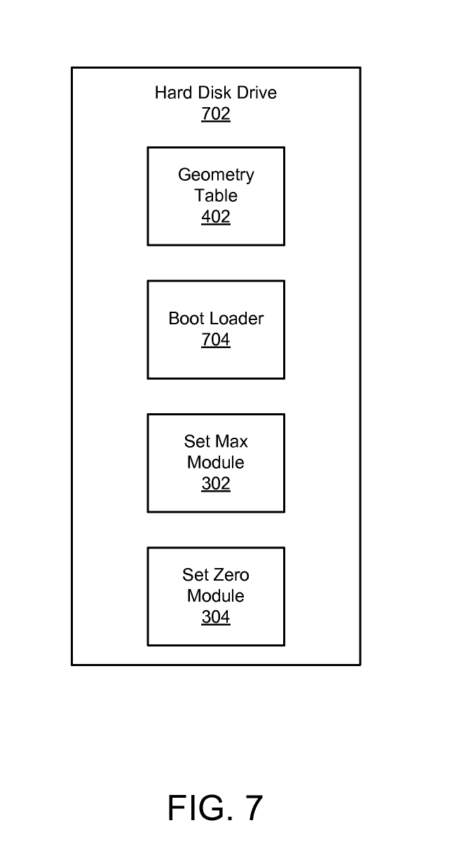

FIG. 7 illustrates one embodiment of an hard disk drive 702 configured to protect one or more areas of the hard disk drive 702 using a geometry table 402 stored on the hard disk drive 702 in accordance with the present invention. The hard disk drive 702 may include a geometry table 402, a boot loader 704, a set max module 302, and a set zero module 304. The geometry table 402 is preferably configured in a similar manner to a like numbered component in relation to FIG. 4. The set max module 302 and the set zero module 304 are preferably configured in a similar manner to like numbered components in relation to FIG. 3. The hard disk drive 702 selectively prevents access to one or more areas of the hard disk drive 702.

The boot loader 704, in one embodiment, is software code stored on the hard disk drive 702 configured to prepare a computer to run another program, such as a subsequent boot loader or an operating system. The boot loader 704 accesses the geometry table 402 to retrieve information relating to hard disk drive areas on the hard disk drive 702. The boot loader 704 may select a hard disk drive area for access and communicate with the set max module 302 and the set zero module 304 to limit access to the hard disk drive 702 as described in relation to FIG. 4. For example, a boot loader 704 may load and direct a user to select among a plurality of operating systems stored on the hard disk drive 702. In response to a selection, the boot loader 704 may access the geometry table 402 to determine the hard disk drive area used by the selected operating system. The boot loader 704 may further direct the set max module 302 and the set zero module 304 to issue a set max command and a set zero command, respectively, allowing access to the selected area and protecting remaining areas of the hard disk drive 702 from access. In addition, the boot loader 704 may start the selected operating system. In a further embodiment, the selection of an operating system requires the input of a proper password.

In one embodiment, the boot loader 704 communicates with a set zero module 304 located on the hard drive 702. As will be appreciated by one skilled in the art, a variety of types and configurations of boot loader 704 and set zero module 304 may be employed without departing from the scope of the invention. For example, in one embodiment, the boot loader 704 may communicate with a set zero module 304 that is separate from the hard disk drive 702. In another embodiment, the boot loader 704 may communicate with a set zero module 304 that is integrated with a controller module.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

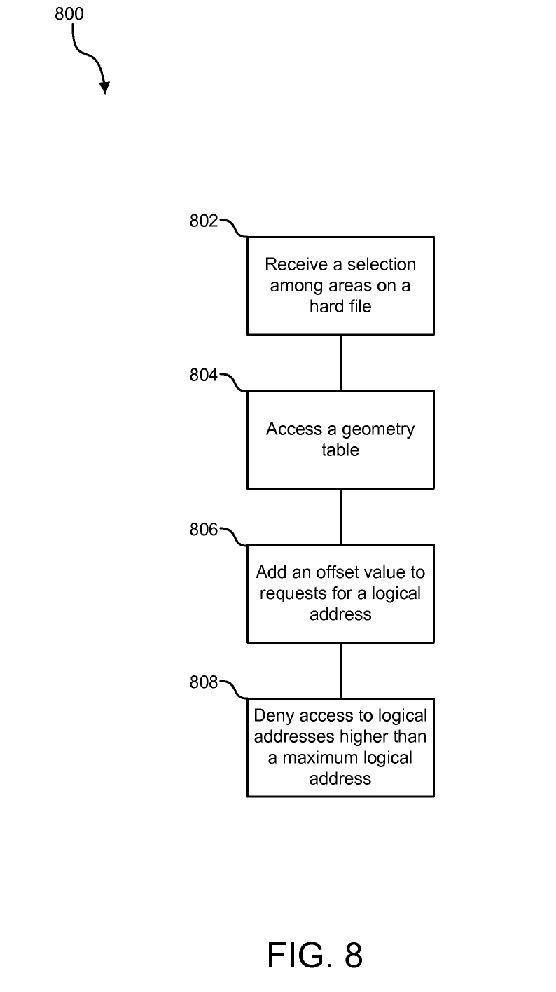

FIG. 8 is a schematic flow chart diagram illustrating the various steps of one embodiment of a method 800 for protecting one or more areas of a hard file. The method 800 is in certain embodiments a method of use of the system and apparatus of FIGS. 2-7, and will be discussed with reference to those figures. Nevertheless, the method 800 may also be conducted independently thereof and is not intended to be limited specifically to the embodiments discussed above with respect to those figures.

As shown in FIG. 8, the method 800 receives 802 a selection among areas on a hard file. The selection indicates which hard file area should be made accessible. The hard file may consist of any digitally-encoded, non-volatile storage medium, such as a hard disk drive, flash memory, an optical disk, or the like. The areas on the hard file may be defined by groups of logical addresses on the hard file. The areas on the hard file, in certain embodiments, contain a plurality of operating systems. For example, the hard file may be a hard disk drive comprising a plurality of disk drive areas, with each disk drive area containing an operating system.

Next, the method 800 accesses 804 a geometry table 402. Accessing 804 the geometry table 402, in one embodiment, may comprise reading persistent storage memory. In another embodiment, accessing 804 a geometry table 402 may comprise reading data stored on the hard file. The geometry table 402 comprises information relating to the logical addresses related to the areas of the hard file. For example, the geometry table 402 may include an offset address for each area of the hard file. In this example, accessing 804 the geometry table 402 may comprise reading an offset value for the area of the hard file selected.

Next, the method 800 adds 806 an offset value to requests for a logical address. By adding 806 an offset value to requests for a logical address, logical addresses below the offset value under the native addressing scheme of the hard file are rendered inaccessible. The offset value is accessed 804 from the geometry table 402 and determines a new logical zero address for the selected area of the hard file. For example, a request for logical address zero has the offset value added 806 to the request, and the method 800 accesses a logical address under the native address system of the hard file equal to the offset value. In one embodiment, adding 806 an offset value to requests for a logical address is carried out through the use of a set zero command.

Next, the method 800 denies 808 access to logical addresses higher than a maximum logical address. In one embodiment, denying 808 access to logical addresses is carried out through the use of a set max command, rendering addresses above a new logical maximum address inaccessible.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to restrict access of a hard file to a range of logical addresses, the apparatus comprising:
a controller module configured to access a hard file in response to a request for a logical address;
a set zero module configured to add an offset value to each request for a logical address on a hard file; and
a set max module configured to set a maximum logical address accessible on a hard file.

2. The apparatus of claim 1, wherein the offset value is determined by a selection among a plurality of hard file areas such that a selection of an area occupying a higher range of logical addresses results in a larger offset value.

3. The apparatus of claim 1, wherein a plurality of hard file areas on a hard file are defined in a geometry table, the geometry table comprising:
a plurality of offset values, each of the plurality of offset values corresponding to the lowest logical address of one of the plurality of hard disk drive areas; and
a plurality of maximum logical address, each of the plurality of maximum logical addresses corresponding to the highest logical address of one of the plurality of hard disk drive areas.

4. The apparatus of claim 1, wherein the set max module sets a maximum logical address relative to the native logical address system of the hard file.

5. The apparatus of claim 1, wherein the set max module sets a maximum logical address relative to the offset value.

6. The apparatus of claim 1, further comprising a locking module configured to:
lock the set zero module such that the set zero module is restricted from changing the offset value; and
unlock the set zero module such that the set zero module is allowed to change the offset value.

7. The apparatus of claim 6 wherein the locking module is further configured to unlock the set zero module in response to a password.

8. The apparatus of claim 6 wherein the locking module is further configured to lock the set zero module in response to a set zero command.

9. A system to protect hard disk data in multiple operating system environments, the system comprising:
a motherboard configured to request data residing on a hard disk drive at a logical address;
a controller module configured to control a hard disk drive, the controller module comprising
a set zero module configured to add an offset value to each request for a logical address on a hard disk drive; and
a set max module configured to set a maximum address accessible on a hard disk drive; and
a hard disk drive configured to store data at logical addresses.

10. The system of claim 9, wherein the set zero module is an element of a hard disk controller integrated with the motherboard.

11. The system of claim 9, wherein the set zero module is an element of a stand alone hard disk controller.

12. The system of claim 9, wherein the set zero module is an element of the hard disk drive.

13. The system of claim 9, wherein the offset value is determined by a selection among a plurality of operating systems, the plurality of operating systems occupying a corresponding plurality of hard disk drive areas, such that a selection of an operating system corresponding to an area occupying a higher range of logical addresses results in a larger offset value.

14. The system of claim 13, wherein the selection among a plurality of operating systems is restricted by a password.

15. The system of claim 9, wherein a plurality of hard disk drive areas on a hard disk drive are defined in a geometry table, the geometry table comprising:
a plurality of offset values, each of the plurality of offset values corresponding to the lowest logical address of one of the plurality of hard disk drive areas; and
a plurality of maximum logical address, each of the plurality of maximum logical addresses corresponding to the highest logical address of one of the plurality of hard disk drive areas.

16. The system of claim 15, wherein the geometry table is stored with a basic input/output system (BIOS) in communication with the controller module.

17. The system of claim 15, wherein the geometry table is stored on the hard disk drive.

18. A computer program product comprising a computer readable medium having computer usable program code programmed for restricting access of a hard file to a range of logical addresses, the operations of the computer program product comprising:
receiving a selection among a plurality of hard file areas on a hard file;
accessing a geometry table, the geometry table comprising:
a plurality of offset values, each of the plurality of offset values corresponding to the lowest logical address of one of the plurality of hard file areas; and
a plurality of maximum logical address, each of the plurality of maximum logical addresses corresponding to the highest logical address of one of the plurality of hard file areas;
adding the offset value to each request for a logical address on the hard file; and
denying access to logical addresses higher than the maximum logical address.

19. The computer program product of claim 18, wherein accessing the geometry table comprises a basic input/output system (BIOS) reading non-volatile BIOS memory.

20. The computer program product of claim 18, wherein accessing the geometry table comprises a boot loader reading data stored on the hard file.

21. A method for restricting access of a hard disk drive to a range of logical addresses comprising:
receiving a selection among a plurality of hard disk drive areas on a hard disk drive;
accessing a geometry table, the geometry table comprising:
a plurality of offset values, each of the plurality of offset values corresponding to the lowest logical address of one of the plurality of hard disk drive areas; and
a plurality of maximum logical address, each of the plurality of maximum logical addresses corresponding to the highest logical address of one of the plurality of hard disk drive areas;
adding the offset value to each request for a logical address on the hard disk drive; and
denying access to logical addresses higher than the maximum logical address.
